(19) United States
(12) Patent Application Publication
(10) Pub. No.: US 2003/0235758 A1
(43) Pub. Date: Dec. 25, 2003

(54) Positive electrode material of Li-ion secondary battery

(75) Inventors: She-Huang Wu, Taipei (TW); Yung-Jen Lin, Taipei (TW); Mu-Rong Yang, Taipei (TW); Wen-Jen Liu, Taipei (TW); Yi-Shiuan Chen, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/458,249

(22) Filed: Jun. 11, 2003

(30) Foreign Application Priority Data
Jun. 21, 2002 (TW) 91113695

(51) Int. Cl. H01M 4/58; C01B 9/00

(52) U.S. Cl. 429/224; 429/231.95; 423/463

(57) ABSTRACT

A positive electrode material of a Li-ion secondary battery is disclosed. This positive electrode material has a formula of Li₁₊ₓMn_{2-y}M_{y}O_{4-z}Cl_{z}, wherein M can be magnesium (Mg), aluminum (Al), chromium (Cr), iron (Fe), cobalt (Co) or nickel (Ni) ions, 0≦x≦0.4, 0≦y≦0.3, and 0.01≦z≦1.0. By means of replacing some oxygen ions of this material with chlorine ions, the crystalline structure thereof can be varied and thus longer life cycle and better stability at high temperature can be achieved.

### BACKGROUND OF THE INVENTION

1. Field of the Invention

The present invention relates to a positive electrode material of an Li-ion secondary battery, which is particularly suitable for being applied to mobile phones, portable computers, portable music players and other electronic devices in which rechargeable batteries serve as power supplies.

2. Related Prior Art

In recent years, Li/Mn oxides with a spinel structure are widely developed for being applied to the positive electrodes of Li-ion secondary batteries. As a well-known factor to performance of the batteries, crystal lattices of the oxides are usually determined by compositions and synthesis methods thereof. Tarascon provides a method in U.S. Pat. No. 5,425,932, in which smaller crystal lattices can be obtained by increasing valence of manganese. Tarascon et al. also provide another method in J. Electrochem. Soc. Vol.138, No.10, pp.2859-2864 (October, 1991), in which the cation replacement is applied.

However, the batteries made by materials of the methods aforementioned are still not satisfied when used at temperatures over 55° C. and a working potential of 4 volts, no matter which metallic ions are replaced. In order to solve this problem, Amatucci provides a solution in U.S. Pat. No. 6,087,072, in which the spinel is synthesized using fluorine or sulfur replacement. However, it may result in serious environmental pollution because fluorine or sulfur is used.

Therefore, it is desirable to provide an improved positive electrode material to mitigate and/or obviate the aforementioned problems.

### SUMMARY OF THE INVENTION

The object of the present invention is to provide a positive electrode material of an Li-ion secondary battery, which exhibits high cell capacity and desirable cycling stability at high temperature.

In order to achieved the above objection, the positive electrode material has a formula of Li₁₋ₓMn_{2-y}M_{y}O_{4-z}Cl_{z}, wherein M is a metallic ion, 0≦x≦0.4, 0≦y≦0.3, and 0.01≦z≦1.0. Preferably, M is magnesium (Mg) ion, aluminum (Al) ion, chromium (Cr) ion, iron (Fe) ion, cobalt (Co) ion or nickel,(Ni) ion, 0≦x≦0.2, 0≦y≦0.1, and 0.01≦z≦0.3.

Other objects, advantages, and novel features of the invention will become more apparent from the following detailed description when taken in conjunction with the accompanying drawings.

### BRIEF DESCRIPTION OF THE DRAWINGS

FIG. 1 shows XRD pattern of Li_{1.06}Mn₂O₄ in accordance with the present invention;

FIG. 2 shows relationship between the crystal lattice constant and z of Li_{1.06}Mn₂O_{4-z}Cl_{z} in accordance with the present invention, wherein z is 0, 0.06, 0.15 and 0.20;

FIG. 3 is a plot of specific capacity and cycling stability v.s. number of charging/discharging cycles for cells comprising cathode compounds of FIG. 2 at 55° C., 3.6-4.3 volts; and

FIG. 4 is a plot of specific capacity and cycling stability vs. number of charging/discharging cycles for cells comprising cathode compounds of Li_{1.00}Mn₂O_{3.94}Cl_{0.06} and Li_{1.06}Mn₂O_{3.94}Cl_{0.06} at room temperature, 3.6-4.3 volts.

### DETAILED DESCRIPTION OF THE PREFERRED EMBODIMENTS

In order to change internal environment of crystal lattices, some oxygen ions in Li/Mn oxides are replaced with chlorine ions in the present invention, whereby the cell capacity and cycling stability thereof at high temperature can be improved. Initial materials used in the present invention are not restricted but comprising the chloride salts which is suitable for providing chlorine ions, and nitrate, chloride, hydroxide, carbonate or acetate of Li and Mn. Various wet chemical processes can be applied to replacing oxygen ions with chlorine ions and synthesizing the positive electrode material, for example, sol-gel method, citric acid-gel method, Pechini process and co precipitating method. The synthesized materials can be further calcined and heated to obtain final products.

When testing, carbon black and polyvinylidene fluoride binder can be added to the positive electrode materials of the present invention and then coated on aluminum foils serving as positive electrodes. In addition to that, lithium foils are provided as negative electrodes. The coated aluminum foil and the lithium foil are arranged in a non-aqueous electrolyte and separated with a separator for testing. The testing can be carried out by repeating charging to 4.3 volts and discharging to 3.6 volts at rate of C/3, i.e., 3 hours for each charging/discharging cycles.

These materials used in the Examples, for example, LiNO₃, Mn(NO₃)₂, NaCl, ethanol and citric acid, are well known by people skilled in this art. The following Examples will be helpful to further understand the present invention.

### EXAMPLE 1

Various Li₁₋ₓMn_{2-y}M_{y}O_{4-z}Cl_{z} are prepared according to the citric acid-gel method, wherein x=0.06, y=0, z=0, 0.06, 0.10, 0.15 and 0.20. First, LiNO₃, Mn(NO₃)₂ and NaCl are dissolved in ethanol in a mole ratio of 1.06:2:z. After uniformly mixing, add ethanol solution with citric acid is added and the solution is kept stirring. Then it is heated to 80° C. for drying. The obtained precursor powders of Li/Mn citrate are then calcined at 300° C. for 2 hours, heated at 800° C. for 4 hours, and cooled down to room temperature at a rate of 1° C./min.

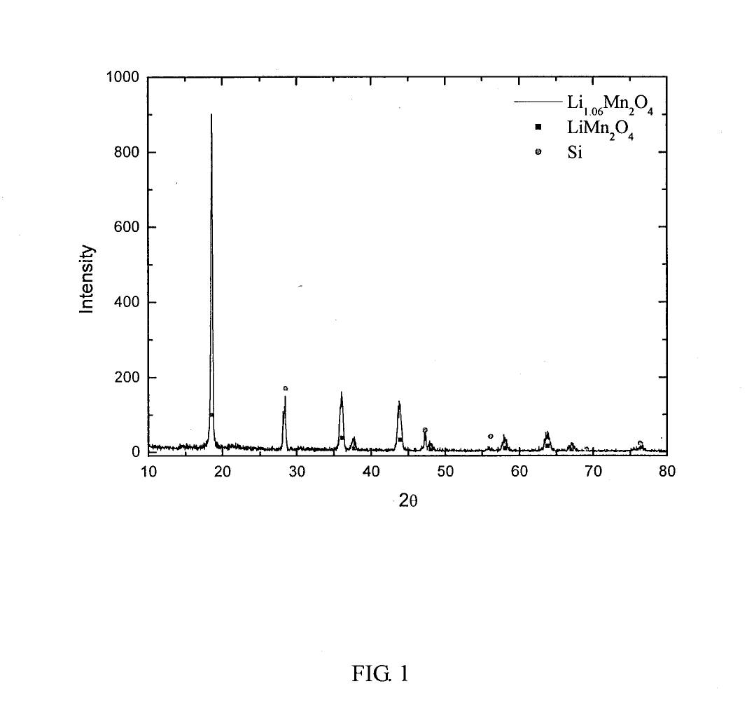

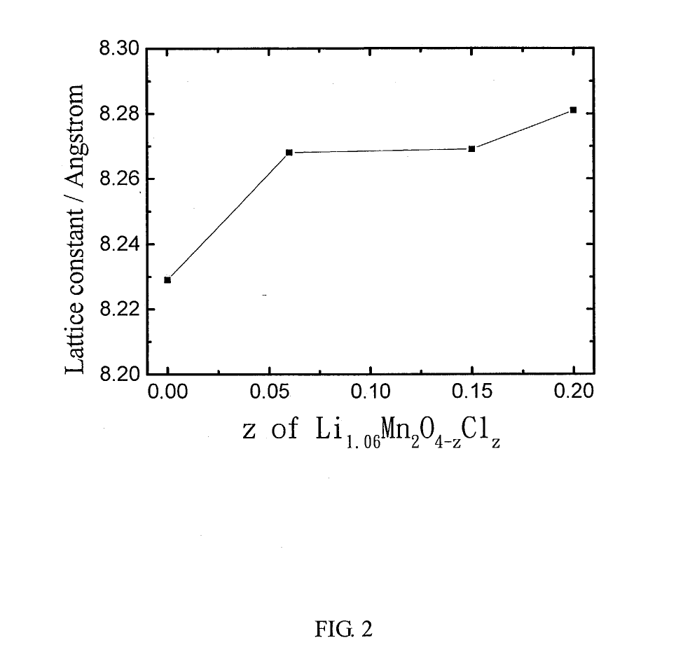

The product Li_{1.06}Mn₂O₄ is characterized by CuKα x-ray diffraction (XRD) examination. As shown in FIG. 1, Li_{1.06}Mn₂O₄ presents a good crystalline structure. FIG. 2 shows relationships between crystal lattice constants and z of all above products obtained in Example 1. The curves in FIG. 2 rise with z, which indicates that the cubic crystal lattice constants are roughly proportioned to amounts of the added chlorine ions.

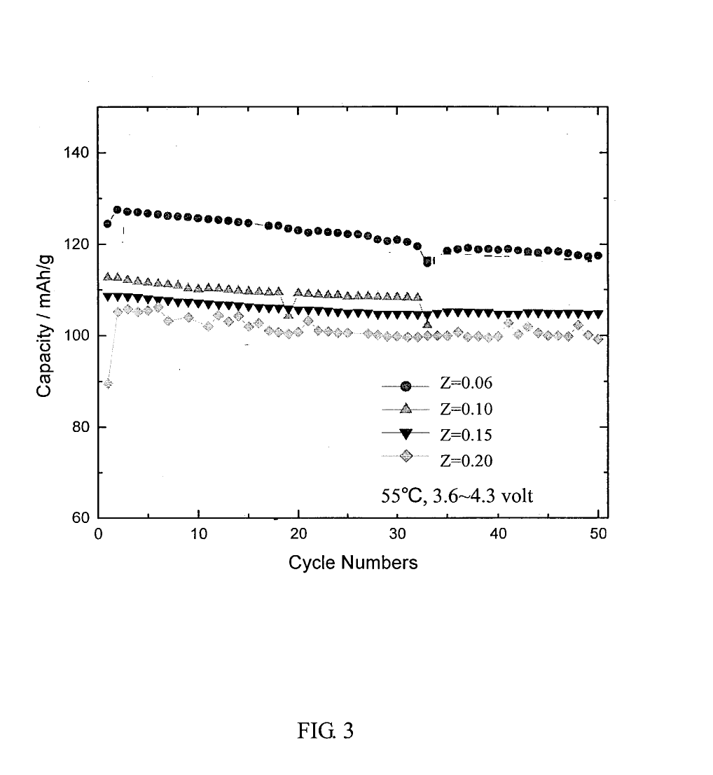

In order to understand performances of the products of the present invention, the binder containing 13 wt. % of carbon black and 7 wt. % of polyvinylidene fluoride is added into the products, which are then coated on aluminum foils for serving as a positive electrode. A lithium foil is provided as a negative electrode. The positive and negative electrodes are separated with a separator and immersed in an electrolyte composed of ethylene carbonate and diethylene carbonate in a volume ratio of 1:1 with 1 M LiPF₆. The tests are respectively carried out at room temperature and 55° C. by repeating cycles of discharging to 3.6 volts and recharging to 4.3 volts for 3 hour in each cycle (C/3). As shown in FIG. 3, the batteries made by the products of the present invention possess high charge capacities and good cycling stabilities at 55° C. Only 0.2% reduction of charge capacities for each cycle indicates that the positive electrode materials produced according to the present invention indeed have excellent cycling performance at high temperature.

### EXAMPLE 2

Repeat procedures of Example 1 to prepare Li₁₊ₓMn_{2-y}M_{y}O_{4-z}Cl_{z}, wherein x=0 and 0.06, y=0, z=0.06.

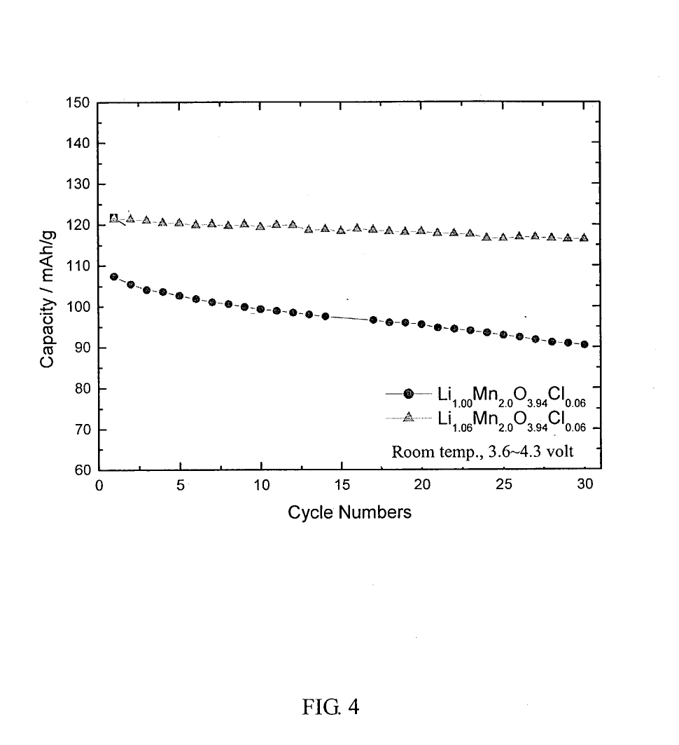

In order to understand performances of the products of Example 2, the binder containing 13 wt. % of carbon black and 7 wt. % of polyvinylidene fluoride is added into the products, which are then coated on aluminum foils for serving as a positive electrode. A lithium foil is provided as a negative electrode. The positive and negative electrodes are separated with a separator and immersed in an electrolyte composed of ethylene carbonate and diethylene carbonate in a volume ratio of 1:1 with 1M LiPF₆. The test is carried out at room temperature by repeating cycles of discharging to 3.6 volts and recharging to 4.3 volts for 3 hour in each cycle (C/3). As shown in FIG. 4, the batteries made by the products of Example 2 also possess high charge capacities and good cycling stabilities at room temperature.

Although the present invention has been explained in relation to its preferred embodiment, it is to be understood that many other possible modifications and variations can be made without departing from the scope of the invention as hereinafter claimed.

What is claimed is:

1. A positive electrode material which is suitable as a Li-ion secondary battery material, said positive electrode material corresponding to the following general formula:
Li₁₊ₓMn_{2-y}M_{y}O_{4-z}Cl_{z}
wherein M is a metallic ion, 0≦x≦0.4, 0≦y≦0.3, and 0.01≦z≦1.0.

2. The positive electrode material as claimed in claim 1, wherein M is selected from the group consisting of magnesium (Mg), aluminum (Al), chromium (Cr), iron (Fe), cobalt (Co) and nickel (Ni) ions.

3. The positive electrode material as claimed in claim 1, wherein 0≦x≦0.2.

4. The positive electrode material as claimed in claim 1, wherein 0≦y≦0.1.

5. The positive electrode material as claimed in claim 1, wherein 0.01≦z≦0.3.
